(19) United States
(12) Patent Application Publication
(10) Pub. No.: US 2025/0153320 A1
(43) Pub. Date: May 15, 2025

(54) ACCESSORY FOR FASTENING TOOL HAVING A PASS-THROUGH DRIVE

(71) Applicant: MILWAUKEE ELECTRIC TOOL CORPORATION, Brookfield, WI (US)

(72) Inventors: Mackenzie J. Nick, Theresa, WI (US); Jacob P. Schneider, Cedarburg, WI (US); Kyle A. Marten, Plymouth, WI (US)

(21) Appl. No.: 18/942,028

(22) Filed: Nov. 8, 2024

Related U.S. Application Data
(60) Provisional application No. 63/560,542, filed on Mar. 1, 2024.
(60) Provisional application No. 63/604,065, filed on Nov. 29, 2023.
(60) Provisional application No. 63/597,879, filed on Nov. 10, 2023.

(51) Int. Cl. B25B 23/00; B25B 21/00

(52) U.S. Cl. CPC B25B 23/0035; B25B 21/002

(57) ABSTRACT

An accessory for a fastening tool having a pass-through drive including a bore bounded by a plurality of drive surfaces includes a coupling portion insertable into the bore from a first side of the bore in a first direction along an axis of the bore, an adapter portion extending from the coupling portion to be coupled to a tool element to perform work on a workpiece, and a lock rotatable relative to the coupling portion between a locked position, in which the lock engages a periphery of the bore, on a second of the bore opposite the first side, to prevent the accessory from being removed from the bore in a second direction opposite the first direction, and an unlocked position, in which the lock aligns with the plurality of drive surfaces to permit removal of the accessory from the bore in the second direction.

### CROSS-REFERENCE TO RELATED APPLICATIONS

The present application claims priority to U.S. Provisional Patent Application No. 63/597,879, filed Nov. 10, 2023, U.S. Provisional Patent Application No. 63/604,065, filed Nov. 29, 2023, and U.S. Provisional Patent Application No. 63/560,542, filed Mar. 1, 2024, the entire contents of each of which is incorporated herein by reference.

### FIELD

The present disclosure relates to fastening tools having a pass-through drive, such as box ratchet tools and nutrunner tools.

### BACKGROUND

A pass-through fastening tool includes a through bore in a drive of the fastening tool, allowing a fastener, workpiece, tool bit, accessory, etc. to extend through the drive. One type of pass-through fastening tool is a ratchet tool and, more specifically, a box ratchet, which may facilitate tightening or loosening a fastener in a confined space where rotation of a tool about a 360-degree axis cannot be undertaken. Other types of pass-through fastening tools include nut runners.

Pass-through fastening tools may require the use of accessories (e.g., adapters) if it is desired to couple certain types of tool bits to the pass-through drive of the tool. The tool bit is coupled to the adapter, and the adapter is then coupled to the tool.

### SUMMARY

It may be desirable to remove the tool bit from the accessory without removing the accessory from the tool. Known accessories may be held in place via friction or detents and can be pulled out of the drive of the tool if applying sufficient force to the tool bit. Accordingly, a need exists for a way to retain an accessory within the drive of a pass-through fastening tool. A further need exists for such an accessory that may still be quickly removed from the drive when desired.

In some aspects, the techniques described herein relate to an accessory for a fastening tool having a pass-through drive including a bore bounded by a plurality of drive surfaces, the accessory including: a coupling portion insertable into the bore from a first side of the bore in a first direction along an axis of the bore to couple the accessory for co-rotation with the pass-through drive about the axis; an adapter portion extending from the coupling portion and configured to be coupled to a tool element to perform work on a workpiece; and a lock rotatable relative to the coupling portion between a locked position, in which the lock engages a periphery of the bore, on a second of the bore opposite the first side, to prevent the accessory from being removed from the bore in a second direction opposite the first direction, and an unlocked position, in which the lock aligns with the plurality of drive surfaces to permit removal of the accessory from the bore in the second direction.

In some aspects, the techniques described herein relate to an accessory, wherein the lock is biased toward the locked position.

In some aspects, the techniques described herein relate to an accessory, wherein the lock is rotatable about the axis.

In some aspects, the techniques described herein relate to an accessory, wherein the lock and the adapter portion are disposed on opposite sides of the coupling portion.

In some aspects, the techniques described herein relate to an accessory, wherein the lock is rotatable between a plurality of locked positions and a plurality of unlocked positions.

In some aspects, the techniques described herein relate to an accessory, further including a detent configured to retain the lock in a selected position of the plurality of locked positions and the plurality of unlocked positions.

In some aspects, the techniques described herein relate to an accessory, wherein the coupling portion has a hexagonal profile, and wherein the adapter portion has a square profile.

In some aspects, the techniques described herein relate to an accessory, further including a flange disposed between the adapter portion and the coupling portion, wherein the flange is engageable with a periphery of the bore on the first side of the bore to limit insertion of the accessory into the bore.

In some aspects, the techniques described herein relate to an accessory, further including a detent ball supported by the adapter portion and configured to engage the tool element when the tool element is coupled to the adapter portion.

In some aspects, the techniques described herein relate to an accessory, wherein the lock includes a body, a first projection extending from the body, and a second projection extending from the body, and wherein the first and second projections are configured to be misaligned with the plurality of drive surfaces when the coupling portion is inserted into the bore and the lock is in the locked position.

In some aspects, the techniques described herein relate to an accessory, wherein the lock further includes a shaft extending from the body into a bore defined within the coupling portion, the shaft including a groove that receives a pin to retain the shaft within the coupling portion.

In some aspects, the techniques described herein relate to an accessory, further including a torsion spring surrounding the shaft, the torsion spring biasing the lock toward the locked position.

In some aspects, the techniques described herein relate to an accessory, further including indicia on the lock to indicate a direction of rotation of the lock from the locked position toward the unlocked position.

In some aspects, the techniques described herein relate to a kit including the accessory, wherein the accessory is a first accessory, and wherein the kit further includes a second accessory including a coupling portion and a lock identical to the coupling portion and the lock of the first accessory, and wherein the second accessory includes an adapter portion extending from the coupling portion and configured to be coupled to a tool element to perform work on a workpiece, the adapter portion of the second accessory being a different size than the adapter portion of the first accessory.

In some aspects, the techniques described herein relate to a kit, further including a third accessory including a coupling portion and a lock identical to the coupling portion and the lock of the first accessory and the second accessory, and wherein the third accessory includes an adapter portion extending from the coupling portion and configured to be coupled to a tool element to perform work on a workpiece, the adapter portion of the third accessory being a different size than the adapter portions of the first and second accessories.

In some aspects, the techniques described herein relate to an accessory for a fastening tool having a pass-through drive including a bore bounded by a plurality of drive surfaces, the accessory including: a coupling portion insertable into the bore in a first direction along an axis of the bore to couple the accessory for co-rotation with the pass-through drive about the axis; an adapter portion extending from the coupling portion and configured to be coupled to a tool element to perform work on a workpiece; and a lock assembly including an actuator, the actuator movable relative to the coupling portion along the axis between a locked position, in which the lock assembly prevents the accessory from being removed from the bore in a second direction opposite the first direction, and an unlocked position, in which the lock assembly permits removal of the accessory from the bore in the second direction.

In some aspects, the techniques described herein relate to an accessory, wherein the lock assembly includes a wedge disposed within the coupling portion, the wedge being movable between an extended position, in which the wedge at least partially extends out of the coupling portion, and a retracted position, in which the wedge is disposed within the coupling portion.

In some aspects, the techniques described herein relate to an accessory, wherein the wedge is movable from the extended position to the retracted position in response to movement of the actuator from the locked position to the unlocked position.

In some aspects, the techniques described herein relate to an accessory, wherein the wedge is one of a plurality of wedges, each movable together between the extended position and the retracted position in response to movement of the actuator.

In some aspects, the techniques described herein relate to an accessory, wherein the wedge is biased toward the extended position.

In some aspects, the techniques described herein relate to a fastening tool including: a housing; a motor supported within the housing; a pass-through drive rotatable about an axis in response to operation of the motor, the pass-through drive including a bore bounded by a plurality of drive surfaces; and an accessory including a coupling portion insertable into the bore in a first direction along the axis to couple the accessory for co-rotation with the pass-through drive about the axis; an adapter portion extending from the coupling portion and configured to be coupled to a tool element to perform work on a workpiece; and a lock rotatable relative to the coupling portion between a locked position, in which the lock engages a periphery of the bore to prevent the accessory from being removed from the bore in a second direction opposite the first direction, and an unlocked position, in which the lock aligns with the plurality of drive surfaces to permit removal of the accessory from the bore in the second direction.

Other features and aspects of the present disclosure are set forth in the following detailed description and accompanying drawings.

### BRIEF DESCRIPTION OF DRAWINGS

FIG. 1 is a perspective view of a box ratchet according to an embodiment of the present disclosure.

FIG. 2 is a cross-sectional view of the box ratchet of FIG. 1.

FIG. 3 is a perspective view of an accessory with a quick-release lock according to an embodiment of the present disclosure, the accessory usable with the box ratchet of FIG. 1.

FIG. 4 is a top perspective view of the quick-release lock of the accessory of FIG. 3.

FIG. 5 is a bottom perspective view of the quick-release lock of the accessory of FIG. 3.

FIG. 6 is a perspective view of the accessory of FIG. 3, illustrating a spring.

FIG. 7 is a perspective view of the accessory of FIG. 3, with the spring hidden.

FIG. 8 is an enlarged view of the accessory of FIG. 3 coupled to the box ratchet of FIG. 1, with the quick-release lock in a locked position.

FIG. 9 is an enlarged view of the accessory of FIG. 3 coupled to the box ratchet of FIG. 1, with the quick-release lock in an unlocked position.

FIG. 10 is an enlarged view of an accessory including a quick-release lock according to another embodiment of the disclosure and coupled to the box ratchet of FIG. 1, with the quick-release lock in a locked position.

FIG. 11 is a perspective view of the accessory of FIG. 10.

FIG. 12 is a cross-sectional view of the accessory of FIG. 11, taken along line 12-12 in FIG. 11.

FIG. 13 is a bottom perspective of a hex cap of the quick-release lock of the accessory of FIG. 11.

FIG. 14 is a perspective view of an accessory including a quick-release lock according to another embodiment of the present disclosure.

FIG. 15 is a cross-sectional view of the accessory of FIG. 14, taken along line 15-15 in FIG. 14.

FIG. 16 is a cross-sectional view of the accessory of FIG. 14, taken along line 16-16 in FIG. 14.

FIG. 17 is transverse cross-sectional view of the accessory of FIG. 14.

FIG. 18 is another transverse cross-sectional view of the accessory of FIG. 14.

FIG. 19 is a cross-sectional view of a portion of the box ratchet of FIG. 1.

FIG. 20 is a perspective view of an accessory according to another embodiment of the present disclosure, the accessory couplable to the box ratchet of FIG. 1.

FIG. 21 is a cross-sectional view of the accessory of FIG. 20 taken along line 21-21 in FIG. 20, the accessory disposed in an undepressed position.

FIG. 22 is a cross-sectional view of the accessory of FIG. 20 taken along line 22-22 in FIG. 20, the accessory disposed in an undepressed position.

FIG. 23 is a cross-sectional view of the accessory of FIG. 20, the accessory disposed in a depressed position.

FIG. 24 is an exploded view of an accessory according to another embodiment of the present disclosure, the accessory couplable to the box ratchet of FIG. 1.

FIG. 24A is a side view illustrating multiple sizes of the accessory of FIG. 24.

FIG. 24B is a perspective view illustrating indicia on the accessory of FIG. 24.

FIG. 25 is a perspective view of a lock couplable to the accessory of FIG. 24.

FIG. 26 is a top perspective view of the accessory of FIG. 24 with a spring.

FIG. 27 is a front view of the accessory of FIG. 24 with a spring.

FIG. 28 is a cross-sectional view of the accessory of FIG. 24.

FIG. 29A is a perspective view of the accessory of FIG. 24 with the lock of FIG. 25, the lock disposed in a locked position.

FIG. 29B is a top view of the accessory of FIG. 24 with the lock of FIG. 25, the lock disposed in a locked position.

FIG. 30A is a perspective view of the accessory of FIG. 24 with the lock of FIG. 25, the lock disposed in an unlocked position.

FIG. 30B is a top view of the accessory of FIG. 24 with the lock of FIG. 25, the lock disposed in an unlocked position.

FIG. 31 is a cross-sectional view of a portion of the box ratchet of FIG. 1, the accessory of FIG. 24 fully inserted into the box ratchet.

FIG. 32 is a is a cross-sectional view of a portion of the box ratchet of FIG. 1, the accessory of FIG. 24 half-way inserted into the box ratchet.

FIG. 33 is a front view of an accessory according to another embodiment of the present disclosure, the accessory couplable to the box ratchet of FIG. 1.

FIG. 34 is a cross-sectional view of the accessory of FIG. 33.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

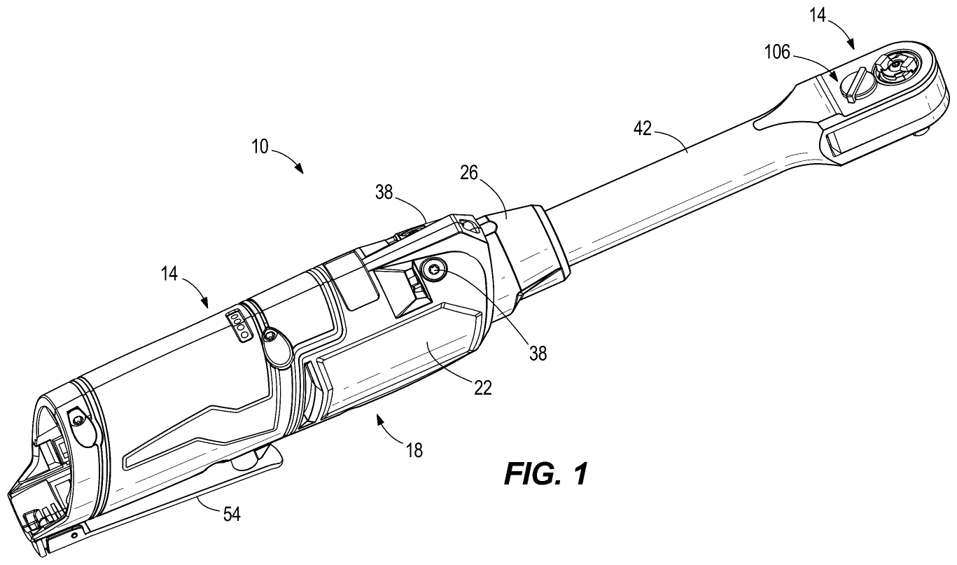

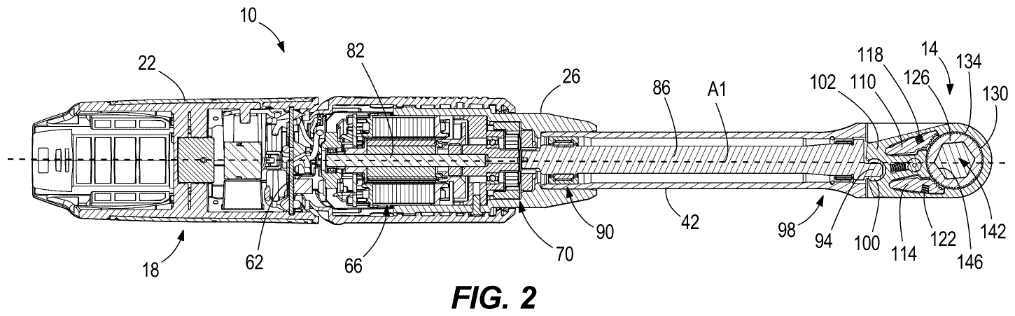

FIG. 1 illustrates an embodiment of a fastening tool with a pass-through drive and, more specifically, a ratchet tool 10 or box ratchet configured to rotate a fastener in clockwise and counterclockwise directions via a ratchet assembly 14. The ratchet tool (also referred to herein simply as “tool”) 10 includes a housing 18 that has a shell 22 and a drive housing 26 that at least partially extends from and is supported in the shell 22. A tool axis A1 (FIG. 2) is defined along the length of the housing 18. As illustrated, the drive housing 26 is coupled to the shell 22 via fasteners 38 spaced circumferentially about the shell 22. A yoke housing 42 is coupled to and extends from the drive housing 26. The ratchet assembly 14 is supported within the yoke housing 42. In the illustrated embodiment, the drive housing 26 and the yoke housing 42 are formed separately and coupled together. In some embodiments, the drive housing 26 and the yoke housing 42 may instead be integrally formed. A battery pack (not shown, but which may be, for instance, a 12-volt battery pack, or a battery pack with another voltage capacity) may be removably coupled to the housing 18, for instance, by sliding the battery pack into the housing 18. The ratchet tool 10 also includes a switch 54 (e.g., trigger) pivotably coupled to the housing 18 and is electrically coupled to the tool 10 such that engagement of the switch 54 activates the tool 10.

With reference to FIG. 2, a printed circuit board assembly (“PCBA”) 62, a motor 66, and a gear assembly 70 are supported in the housing 18. The PCBA 62 includes a controller that controls operation of the tool 10. The gear assembly 70 is operationally coupled to a rotor shaft 82 of the motor 66 to receive a rotational input and transmit the rotational motion of the rotor shaft 82 to the ratchet assembly 14.

A crankshaft 86 is at least partially disposed in the yoke housing 42. A first end 90 of the crankshaft 86 engages the gear assembly 70 and is rotatable about the tool axis A1 with a portion of the gear assembly 70. The crankshaft 86 further defines a coupling portion 94 that extends from the second end 98 of the crankshaft 86. The coupling portion 94 is radially offset from the tool axis A1 such that the coupling portion 94 is eccentrically oriented relative to the crankshaft 86. A bearing 100 (e.g., a spherical bearing) is coupled to the coupling portion 94 of the crankshaft 86. The bearing 100 engages the ratchet assembly 14 and transmits rotation of the coupling portion 94 to the ratchet assembly 14.

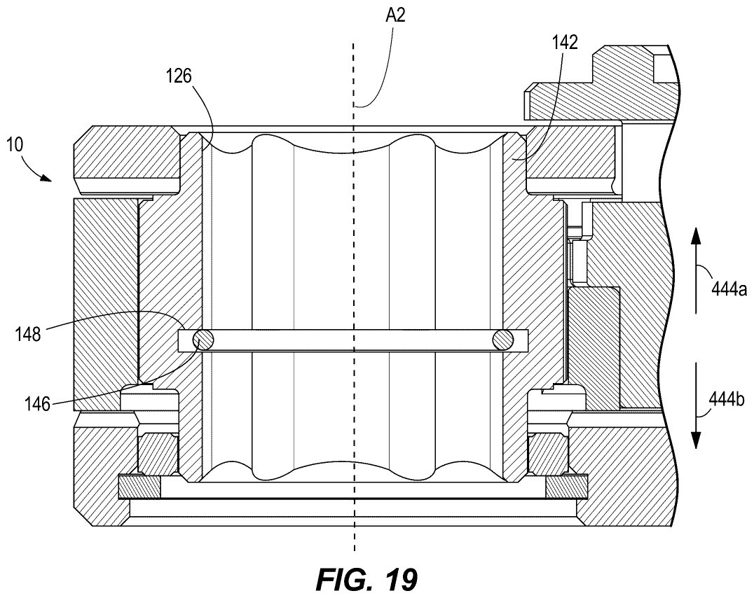

With continued reference to FIG. 2, the ratchet assembly 14 is shown in greater detail. The ratchet assembly 14 is pivotable relative to the yoke housing 42 about a fastening axis A2 (FIG. 19) which is substantially perpendicular to the tool axis A1, although other angular relationships between the tool axis A1 and the fastening axis A2 may be present in other embodiments. The ratchet assembly 14 includes a yoke 102, a forward-reverse assembly 106 (FIG. 1), a left pawl 110 and a right pawl 114, biasing members (e.g., a first biasing member 118 and a second biasing member 122; FIG. 2), and a drive 126, which, in the illustrated embodiment, includes a splined outer periphery 130 configured to interface with the pawls 110, 114. The yoke 102 further defines a fastening hole 134 configured to receive the drive 126. The left and right pawls 110, 114, the forward-reverse assembly 106, and the first and second biasing members 118, 122 are supported within the yoke 102.

The drive 126 is rotatably supported in the fastening hole 134 of the yoke 102 and rotates about the fastening axis A2. The splined outer periphery 130 of the drive 126 includes a plurality of teeth positioned circumferentially about the outer periphery 130. The drive 126 further defines a drive bore 142, extending centrally along the fastening axis A2 (FIGS. 2 and 19). As illustrated, the drive bore 142 is bounded by a plurality of drive surfaces such that the drive bore 142 has a hexagonal cross-section. In other embodiments, the drive bore 142 may have a different cross section (e.g., square, Torx, etc.). A groove 148 (FIG. 19) extends about the circumference of the drive bore 142 and receives an accessory retention spring 146 therein. The accessory retention spring 146 may be an O-ring made of a resilient material. The accessory retention spring 146 extends at least partially into the drive bore 142 (in a radially inward direction) and may engage an accessory to frictionally retain the accessory within the drive bore 142. In other embodiments, the groove 148 and the accessory retention spring 146 may be omitted. In another embodiment, an o-ring may be provided behind the retention spring 146 (i.e., surrounding an outer diameter of the retention spring 146). The o-ring can assist in providing a uniform application of a retention force on an accessory, such as the accessories described in greater detail below.

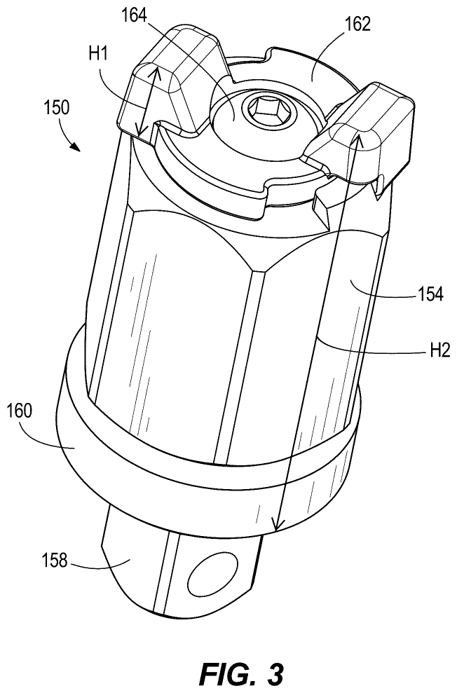

With reference to FIGS. 1 and 3, an accessory 150 is configured to couple a tool element (e.g., a socket, tool bit, etc.) to the drive 126 of the box ratchet 10 to perform work on a workpiece (e.g., a fastener). In some embodiments, the accessory 150 may be configured to directly engage and perform work on a workpiece (e.g., the accessory 150 may include a socket, a screwdriver head, etc.).

The illustrated accessory 150 includes a coupling portion 154 and an adapter portion 158. The coupling portion 154 of the accessory 150 has a hexagonal cross-sectional profile and is configured to be received within the drive bore 142 of the drive 126. That is, the coupling portion 154 of the accessory 150 may be inserted into the drive bore 142 in a direction along the axis A2. A flange 160 is formed along the coupling portion 154 and functions as a stopping member configured to prevent the accessory 150 from falling through the drive 126 in the insertion direction. The illustrated adapter portion 158 has a square cross-sectional profile and is configured to be coupled to the tool element.

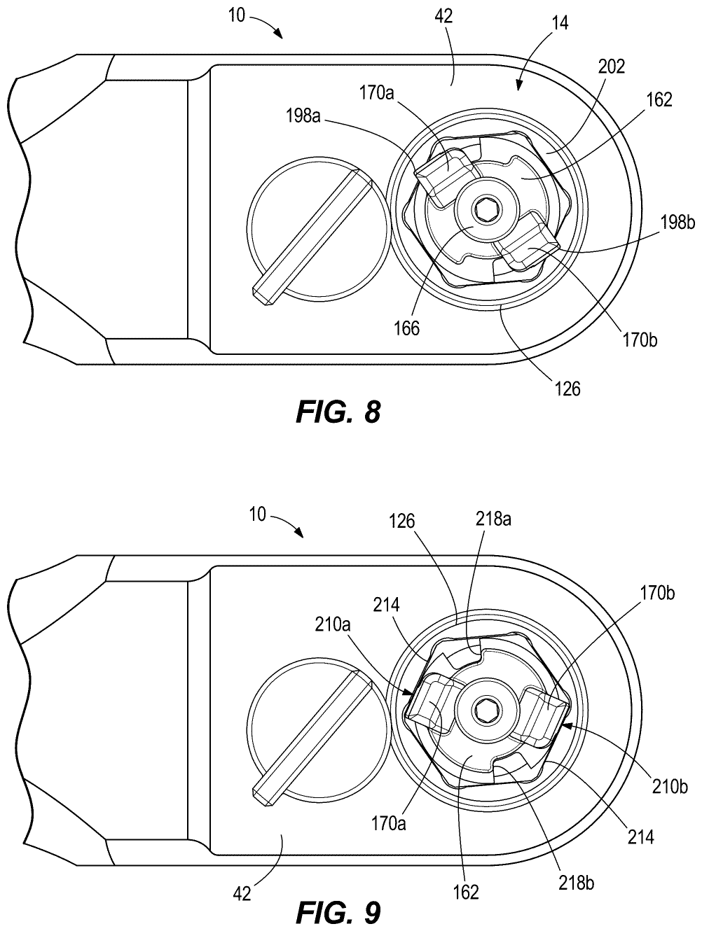

With reference to FIGS. 3-7, a quick-release lock 162 is coupled to the accessory 150 (e.g., by a fastener 164) to help maintain the accessory 150 within the drive 126. That is, the lock 162 may prevent inadvertent removal of the accessory 150 from the drive bore 142 of the drive 126. The illustrated lock 162 includes a body 166, a first projection 170a extending from the body 166, and a second projection 170b also extending from the body 166. The first and second projections 170a, 170b are spaced from each other and provided on opposite sides of the lock 162. The lock 162 is rotatable relative to the accessory 150 such that the lock 162 is movable between a locked position and an unlocked position. In the locked position (FIG. 8), the lock 162 prevents removal of the accessory 150 from the tool 10. In the unlocked position (FIG. 9), the lock 162 is positioned such that removal of the accessory 150 from the tool 10 is permitted.

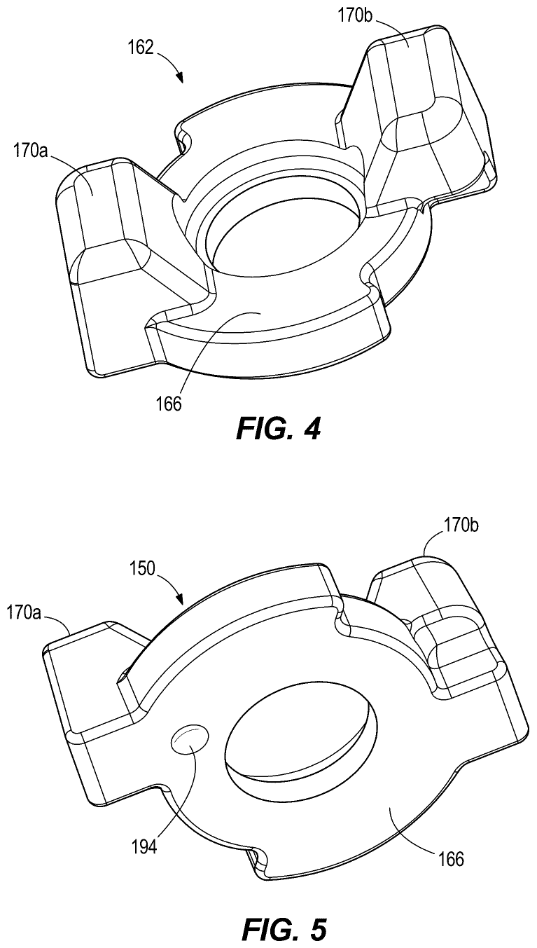

A spring 178 is provided within a bore 182 of the accessory 150. Specifically, the spring 178 includes a first end (not shown) configured to be received within a first recess 184 defined within an end surface 186 of the bore 182 and a second end 190 configured to be received within a second recess 194 (FIG. 5) defined within the body 166 of the lock 162. As such, the spring 178 biases the lock 162 into the locked position upon fully inserting the accessory 150 into drive bore 142 of the drive 126.

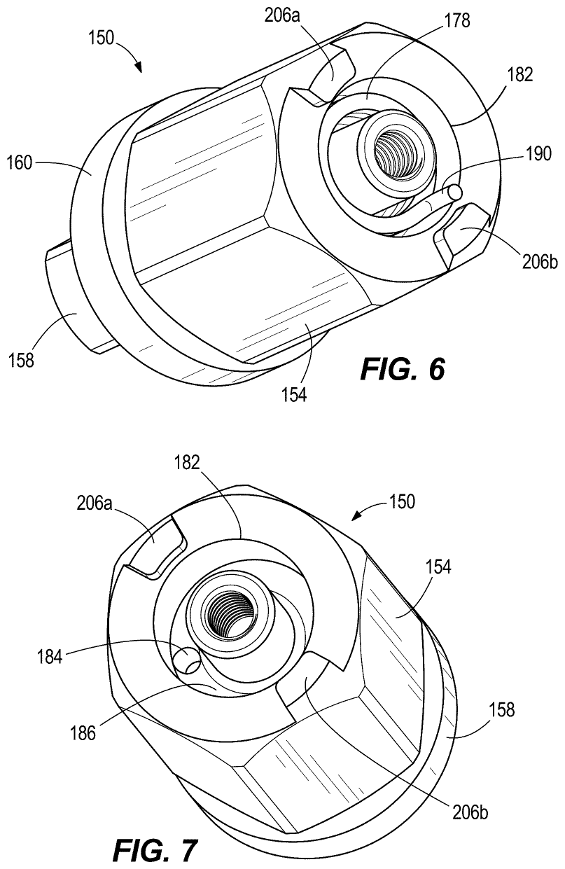

With reference to FIG. 8, the lock 162 is illustrated in the locked position. After fully inserting the accessory 150 into the drive 126, the spring 178 biases the lock 162 to the locked position such that the corners 198a, 198b of the first and second projections 170a, 170b engage a flat top surface 202 of the drive 126 to lock the accessory 150 in place. Each projection 170a, 170b is configured to abut respective tabs 206a, 206b (FIGS. 6 and 7) formed on the coupling portion 154 of the accessory 150. In addition, the projections 170a, 170b are misaligned with the drive surface of the drive bore 142 in the locked position. As such, in the locked position, the lock 162 increases retention between the accessory 150 and the tool 10 to prevent the accessory 150 from being pulled through the tool 10.

With reference to FIG. 9, the lock 162 is illustrated in the unlocked position. A user may rotate the lock 162 in a clockwise direction or a counterclockwise direction to move the lock 162 into the unlocked position. Once respective flat sides 210a, 210b of the first and second projections 170a, 170b become parallel with flat edges 214 of the drive bore 142 of the drive 126, the accessory 150 is allowed to be removed from the tool 10. Also, first and second edges 218a, 218b defined along the body 166 of the lock 162 are configured to respectively abut the tabs 206a, 206b of the accessory 150 to prevent further rotation of the lock 162.

With reference to FIG. 3, a first height H1 is defined between a top surface of the lock 162 and a bottom surface of the lock 162, thereby defining a height of the lock 162. Also, a second height H2 is defined between the top surface of the lock 162 and a bottom surface of the flange 160 of the accessory 150. The accessory 150 is provided with a low profile and small head height by minimizing the first height H1 and the second height H2. In the illustrated embodiment, a ratio of the first height H1 to the second height H2 is about 1 to 6. As such, the lock 162 is configured to be a small adapter, but not so small that it will be difficult for a user to grasp the lock 162.

In operation, a user depresses the switch 54 to actuate the motor 66. In response to actuation of the switch 54 and the motor 66, the crankshaft 86 and the coupling portion 94 are rotated such that the bearing 100 engages the yoke 102 to rotate the ratchet assembly 14 about the fastening axis A2. As the ratchet assembly 14, and the left and right pawls 110, 114 with it, are rotated, the left or right pawl 110, 114, depending on the position of the forward-reverse assembly 106, will be engaged with the drive 126 to rotationally advance the drive 126 and rotate the accessory 150.

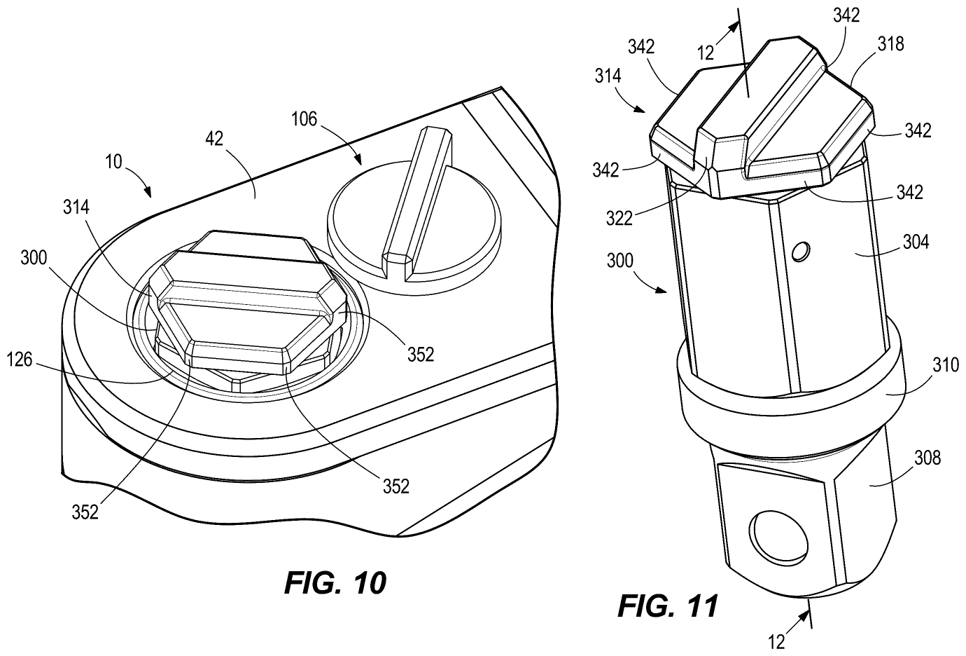

FIGS. 10-13 illustrate an accessory 300 according to another embodiment, which may be coupled to and used with the ratchet tool 10. The illustrated accessory 300 includes a coupling portion 304 and an adapter portion 308. The coupling portion 304 of the accessory 300 has a hexagonal cross-sectional profile and is configured to be received within the drive bore 142 of the drive 126. A flange 310 is formed along the coupling portion 304 and functions as a stopping member configured to prevent the accessory 300 from falling through the drive 126. The adapter portion 308 has a square cross-sectional profile and is configured to be coupled to a tool element (e.g., a socket, tool bit, etc.) to perform work on a workpiece (e.g., fastener).

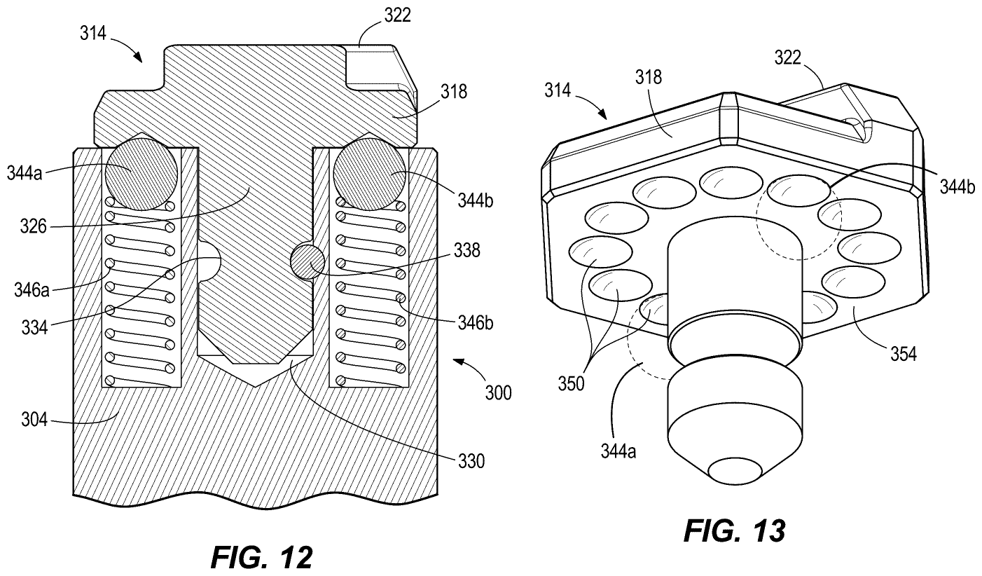

A quick-release lock 314 is coupled to the accessory 300 to help maintain the accessory 300 within the drive 126. The lock 314 includes a hex cap 318, a gripping actuator 322 extending from the hex cap 318, and a shaft 326 also extending from the hex cap 318 (FIG. 12). The shaft 326 is received in a bore 330 defined within the coupling portion 304 of the accessory 300. A groove 334 is defined along a periphery of the shaft 326 of the lock 314 and is configured to receive a pin 338 extending through the coupling portion 304. The pin 338 is fitted between the shaft 326 of the lock 314 and the bore 330 of the coupling portion 304 to retain the shaft 326 within the accessory 300.

The hex cap 318 of the lock 314 has an outer profile corresponding with the hexagonal cross-section of the drive bore 142 of the drive 126 and the hexagonal cross-section of the coupling portion 304. As such, the hex cap 318 has a plurality of flat sides 342 to form a cap with a hexagonal shape. The gripping actuator 322 may be grasped by a user to rotate the lock 314 relative to the accessory 300 such that the lock 314 is movable between a locked position and an unlocked position. In the locked position (FIG. 10), the lock 314 prevents removal of the accessory 300 from the tool 10. In the unlocked position, the lock 314 is positioned such that removal of the accessory 300 from the tool is permitted.

The accessory 300 further includes a pair of detent balls 344a, 344b biased against the lock 314 by respective springs 346a, 346b. The detent balls 344a, 344b are biased into individual recesses 350 (FIG. 13) defined within a bottom surface 354 of the lock 314. In the illustrated embodiment, the lock 314 has 12 recesses 350. The lock 314 is movable between 12 different positions (i.e., six locked positions and six unlocked positions) via the engagement between the detent balls 344a, 344b and the recesses 350. As such, the detent balls 344a, 344b are configured to retain the lock 314 within a specific orientation.

With reference to FIG. 10, the lock 314 is illustrated in one of the locked positions. The lock 314 is rotated such that corners 352 of the lock 314 engages the top surface 202 of the drive 126 (at a periphery of the drive bore 142) to lock the accessory 300 in place. The lock 314 is provided to increase retention between the accessory 300 and the tool 10 to prevent the accessory 300 from being pulled through the tool 10. The lock 314 may then be rotated by a user to be disposed in one of the unlocked positions such that the flat sides 342 of the lock 314 are parallel with the flat edges 214 of the drive bore 142 (FIGS. 8 and 9) of the drive 126 to allow removal of the accessory 300 from the tool 10.

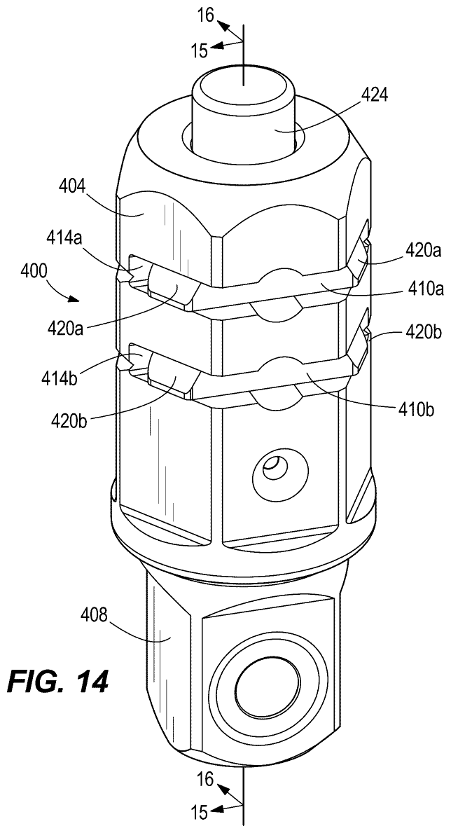

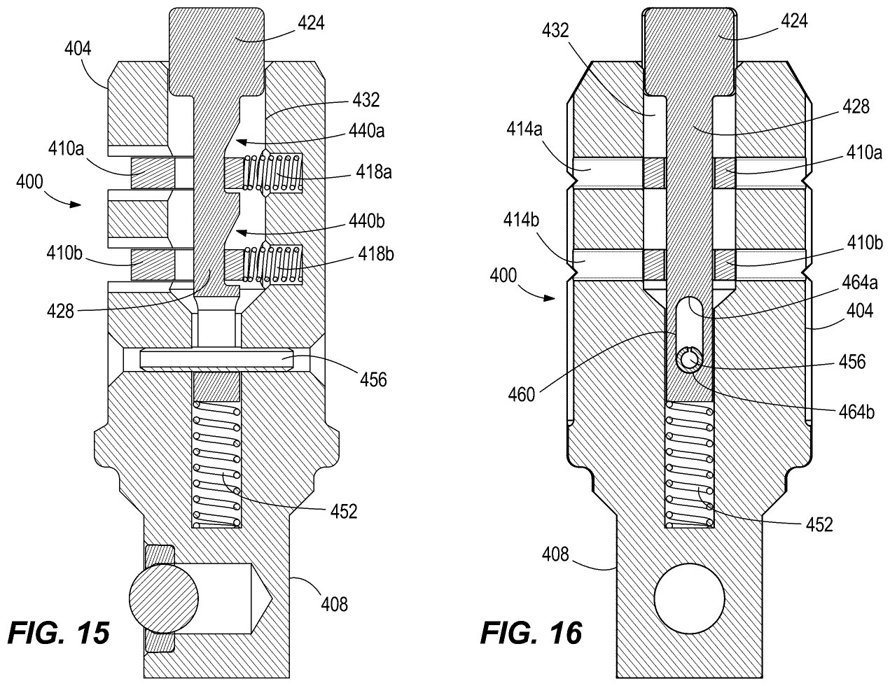

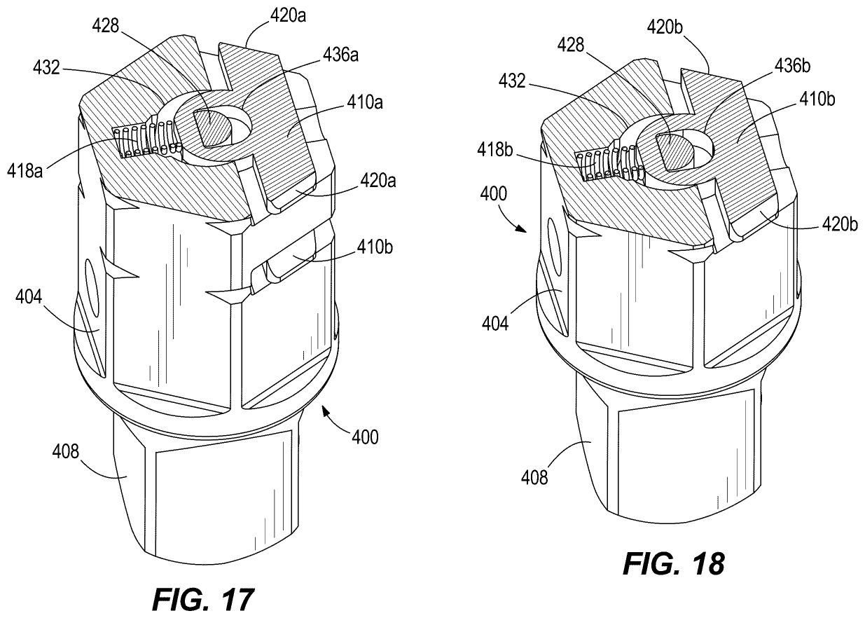

FIGS. 14-19 illustrate an accessory 400 according to another embodiment, which may be coupled to and used with the ratchet tool 10. The illustrated accessory 400 includes a coupling portion 404 and an adapter portion 408. The coupling portion 404 of the accessory 400 has a hexagonal cross-sectional profile and is configured to be received within the drive bore 142 of the drive 126. The adapter portion 408 has a square cross-sectional profile and is configured to be coupled to a tool element (e.g., a socket, tool bit, etc.) to perform work on a workpiece (e.g., fastener).

The illustrated accessory 400 includes a quick-release locking assembly with a first wedge 410a and a second wedge 410b disposed in respective cutouts 414a, 414b defined within the coupling portion 404. The wedges 410a, 410b are movable between a retracted position and an extended position. A first spring 418a and a second spring 418b are provided to respectively bias the wedges 410a, 410b into the extended position such that the wedges 410a, 410b extend out of the accessory 400. More specifically, chamfered edges 420a, 420b, defined on each wedge 410a, 410b, are provided to extend out of the accessory 400 for engagement with the tool 10. Although the accessory 400 includes two wedges 410a, 410b in the illustrated embodiment, in other embodiments, the accessory 400 may include a different number of wedges, such as a single wedge 410a.

The locking assembly of the accessory 400 further includes an actuator in the form of a button 424 configured to be depressed by a user to permit removal of the accessory 400 from the tool 10. A shaft 428 is integrally formed with the button 424 and extends through a bore 432 defined within the accessory 400. The shaft 428 also extends through holes 436a, 436b respectively defined in the wedges 410a, 410b. In addition, two notches 440a, 440b are defined within the shaft 428 and are configured to cooperate with the wedges 410a, 410b to move each wedge 410a, 410b between the retracted position and the extended position.

The accessory 400 is configured to be inserted into the drive 126 in a first insertion direction 444a or a second insertion direction 444b opposite the first insertion direction 444a. When inserting the accessory 400 in the first insertion direction 444a, the accessory 400 is placed in a first position such that the adapter portion 408 extends from a side of the tool 10 in which the switch 54 is disposed. When inserting the accessory 400 in the second insertion direction 444b, the accessory 400 is placed in a second position such that the adapter portion 408 extends from a side of the tool 10 in which the forward-reverse assembly 106 is disposed.

Once the accessory 400 is fully inserted into the drive bore 142 of the drive 126, one of the wedges 410a, 410b engages a groove 148 defined within the drive bore 142 to lock the accessory 400 within the drive 126. The groove 148 is not centrally disposed within the drive 126, and therefore allows the accessory 400 to lockingly engage the drive 126 in the first position or the second position. In the first position, the groove 148 is configured to receive the second wedge 410b, more specifically the chamfered edges 420b of the second wedge 410b, as the first wedge 410a is biased against drive bore 142 of the drive 126. In the second position, the groove 148 is configured to receive the first wedge 410a, more specifically the chamfered edges 420a of the first wedge 410a, as the second wedge 410b is biased against the drive bore 142 of the drive 126.

To allow removal of the accessory 400 from the tool 10, a user may depress the button 424 to downwardly displace the shaft 428 against a third spring 452. As the shaft 428 shifts downward upon depression of the button 424, the first and second wedges 410a, 410b are moved from the extended position to the retracted position. The wedges 410a, 410b ride along the contour of the notches 440a, 440b and are pushed against the first and second springs 418a, 418b to be entirely disposed within the coupling portion 404. Depending on the orientation of the accessory 400, a respective wedge 410a, 410b then disengages the groove 148 to allow removal of the accessory 400.

The illustrated accessory 400 includes a pin 456 disposed within the coupling portion 404. The pin 456 extends through a slot 460 defined within the shaft 428 to limit the displacement of the shaft 428 and prevent removal of the shaft 428 from the bore 432. When the button 424 is depressed, the pin 456 is configured to abut a first end 464a of the slot 460 to stop further displacement of the shaft 428 within the coupling portion 404. As the button 424 is undepressed, the pin 456 abuts a second end 464b of the slot 460 to limit an amount at which the button 424 extends out of the bore 432 of the accessory 400 when biased by the third spring 452.

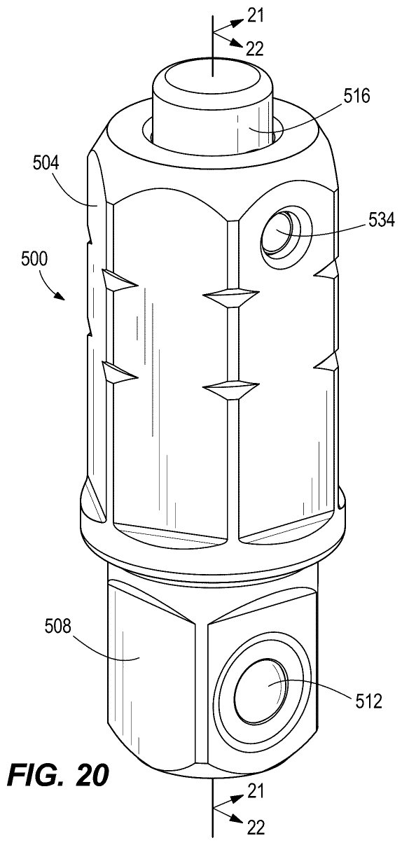

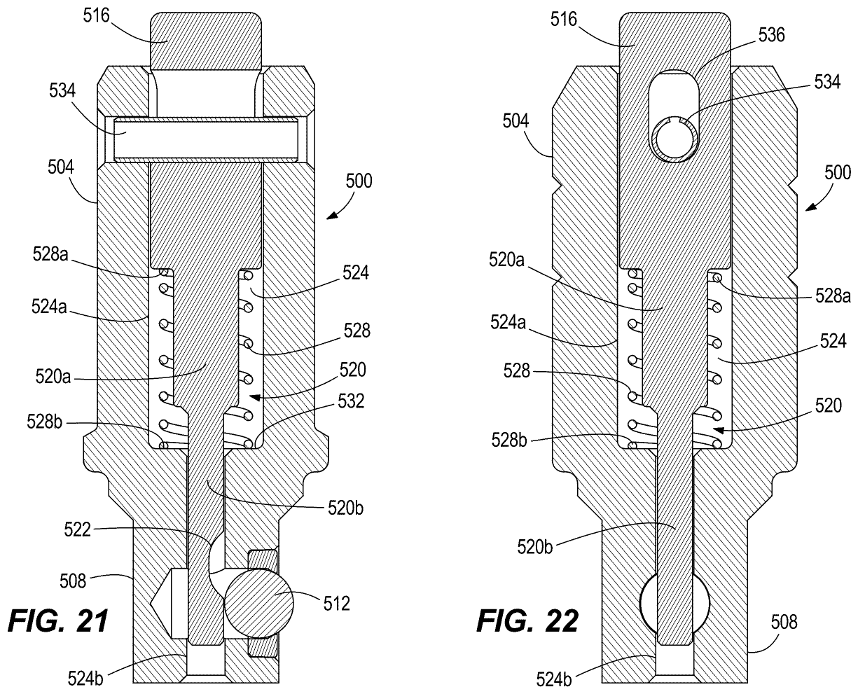

FIGS. 20-23 illustrate an accessory 500 according to another embodiment, which may be coupled to and used with the ratchet tool 10. The illustrated accessory 500 includes a coupling portion 504 and an adapter portion 508. The coupling portion 504 of the accessory 500 has a hexagonal cross-sectional profile and is configured to be revived within the drive bore 142 of the drive 126. The adapter portion 508 has a square cross-sectional profile and is configured to be coupled to a tool element (e.g., a socket, tool bit, etc.). A detent ball 512 is provided within the adapter portion 508 and configured to engage the tool element to help couple the tool element to the adapter portion 508.

The accessory 500 also includes a button 516 and a shaft 520 integrally formed with the button 516. The button 516 is configured to be depressed by a user to permit removal of the tool element from the adapter portion 508 of the accessory 500. The shaft 520 is formed by a first shaft portion 520a and a second shaft portion 520b that is smaller than the first shaft portion 520a. A concave recess 522 is defined within the second shaft portion 520b and configured to receive the detent ball 512 upon depression of the button 516. The shaft 520 is disposed in a through bore 524 defined within the accessory 500. The bore 524 is formed by a first bore portion 524a and a second bore portion 524b that is smaller than the first bore portion 524a.

The accessory 500 further includes a spring 528 arranged around the shaft 520. A first end 528a of the spring 528 engages the button 516 and a second end 528b of the spring 528 is disposed at an end surface 532 of the first bore portion 524a. The spring 528 is configured to bias the button 516 out of the first bore portion 524a when the button 516 is not depressed by a user. As such, the second shaft portion 520b is positioned to abut the detent ball 512 and push a portion of the detent ball 512 out of the accessory 500 for engagement with a tool element.

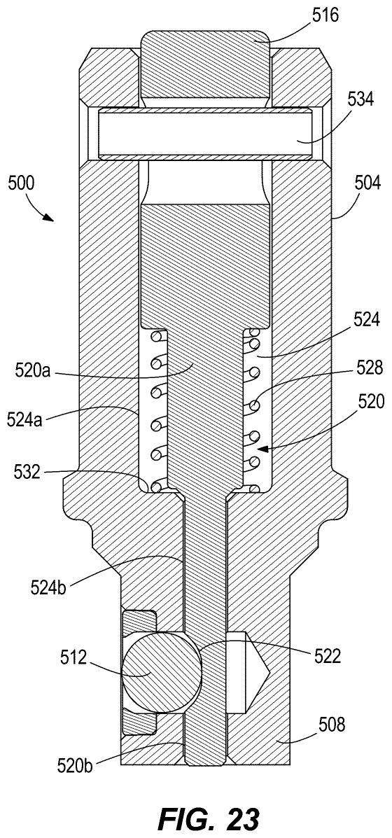

When a user depresses the button 516, as illustrated in FIG. 23, the shaft 520 is downwardly displaced such that the first shaft portion 520a abuts the end surface 532 of the first bore portion 524a. The concave recess 522 of the second shaft portion 520b becomes aligned with the detent ball 512. The detent ball 512 is then permitted to disengage the tool element and be received within the concave recess 522 for removal of the tool element. The button 516 allows the tool element to be released from the accessory 500 at a force less than an ejection force that is produced when removing the accessory 500 from the tool 10. As such, the accessory 500 is prevented from being removed from the tool 10 when the user removes the tool element from the accessory 500.

Moreover, the accessory 500 includes a pin 534 disposed within the coupling portion 504. The pin 534 extends through a slot 536 defined within the first shaft portion 520a to further limit displacement of the of the shaft 520. When the button 516 is depressed, the pin 534 is configured to abut the slot 536 to stop further displacement of the shaft 520. The pin 534 also prevents removal of the button 516 from the bore 524.

Thus, the present disclosure provides, among other things, an accessory for use with a ratchet tool, with a quick-release mechanism actuatable to conveniently permit removal of the accessory from the ratchet tool (and/or a tool bit from the accessory) but to prevent inadvertent removal or detachment of the accessory from the ratchet tool.

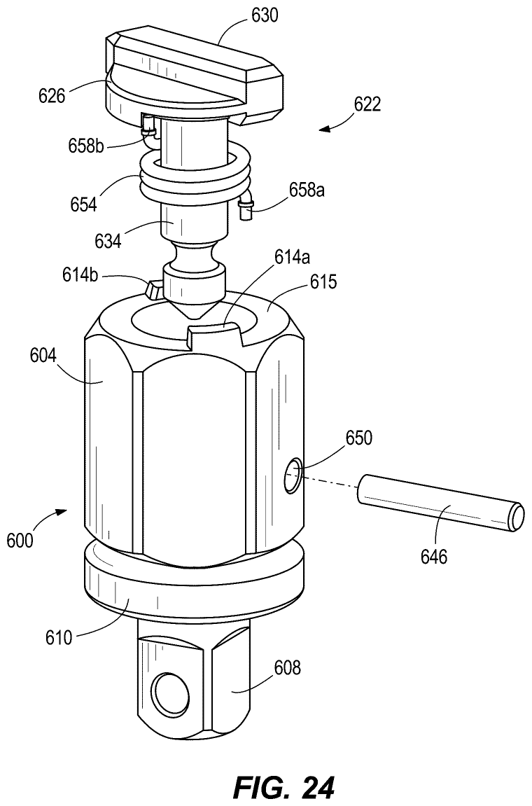

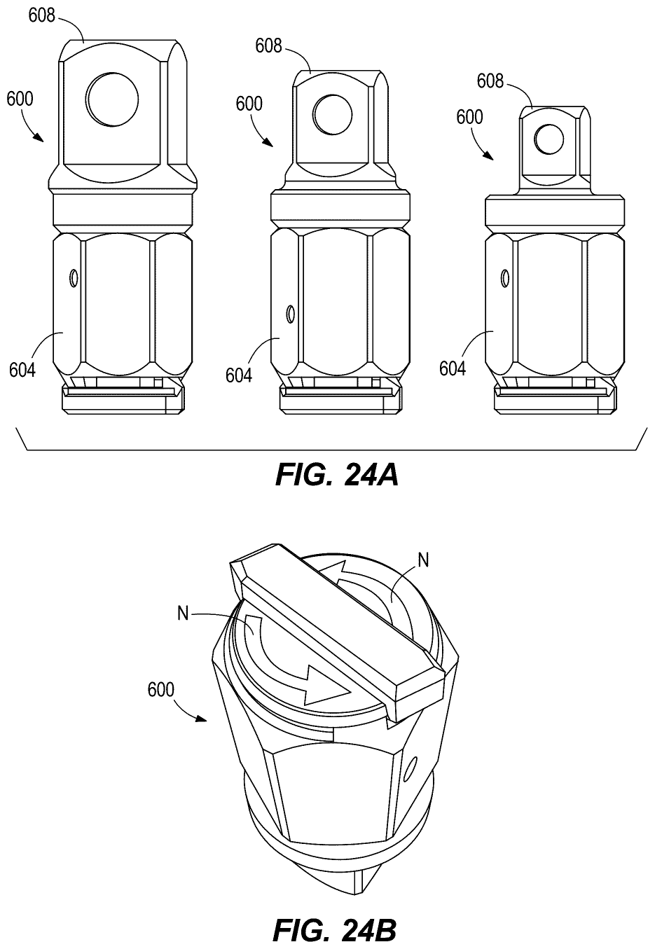

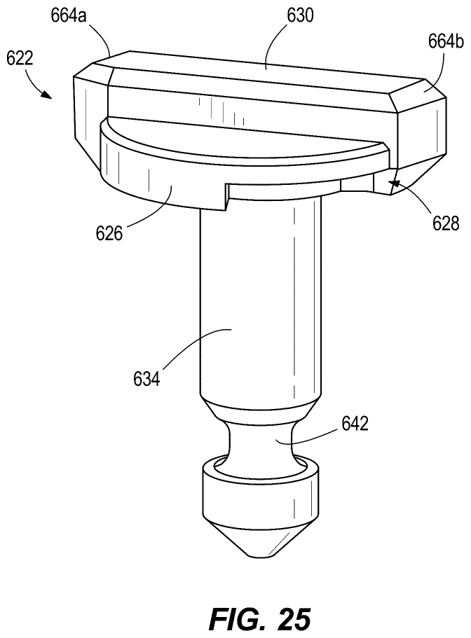

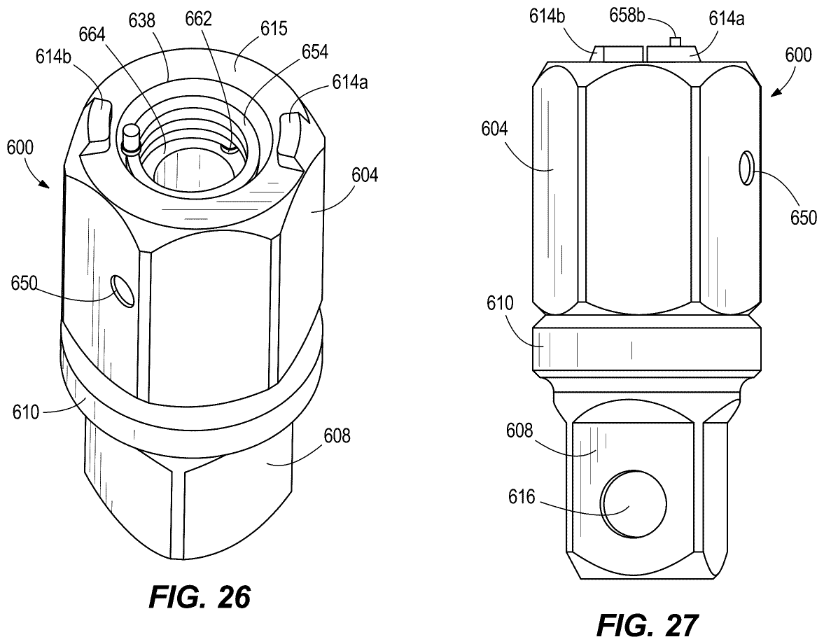

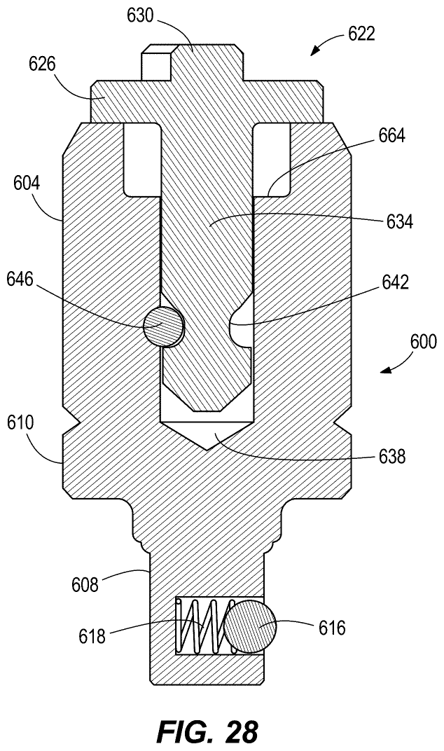

FIGS. 24-28, 31, and 32 illustrate an accessory 600 according to another embodiment, which may be coupled to and used with the ratchet tool 10. The illustrated accessory 600 includes a coupling portion 604, an adapter portion 608, and a flange 610 formed along the coupling portion 604. The coupling portion 604 of the accessory 600 has a hexagonal cross-sectional profile and is configured to be received within the drive bore 142 of the drive 126. The coupling portion 604 also has two locking projections 614a, 614b formed along a top surface 615 of the coupling portion 604. The adapter portion 608 has a square cross-sectional profile and is configured to be coupled to a tool element (e.g., socket, tool bit, etc.) to perform work on a workpiece (e.g., fastener). The flange 610 functions as a stopping member configured to prevent the accessory 600 from falling through the drive 126. A detent ball 616 (FIG. 26) is provided within the adapter portion 508 and is biased by a spring 618 to engage the tool element to help couple the tool element to the adapter portion 608.

As shown in FIG. 24A, in various embodiments, the adapter portion 608 of the accessory 600 may come in different sizes (e.g., ½″, ⅜″, ¼″, etc.), while the coupling portion 604 may be the same size in each case. As such, the accessory 600 may be one of a set of differently sized accessories 600, each with an identical coupling portion 604 compatible with the ratchet tool 10 such that the accessories 600 are interchangeable. The set of differently sized accessories 600 may be provided as a kit, which, in some embodiments, may include a container (not shown) that may be utilized to easily transport multiple accessories 600.

Returning to FIG. 24. a quick-release lock 622 is coupled to the accessory 600 to help maintain the accessory 600 within the drive 126. The lock 622 includes a cap 626 with a pair of recesses 628 defined therein, a gripping actuator 630 extending from the cap 626, and a shaft 634 also extending from the cap 626 in a direction opposite the gripping actuator 630. The shaft 634 of the lock 622 is received in a bore 638 (FIG. 26) defined within the coupling portion 604 of the accessory 600. A groove 642 is defined along a periphery of the shaft 634 of the lock 622 and is configured to receive a pin 646 extending through a hole 650 defined within the coupling portion 604. The pin 646 is press-fitted into the hole 650 to be disposed between the shaft 634 of the lock 622 and the bore 638 of the coupling portion 604. The hole 650 of the coupling portion 604 has chamfered openings that assist with the press-fit procedure. As such, the pin 646 retains the shaft 634 within the accessory 600 and prevents removal of the lock 622.

A spring 654 (e.g., a torsion spring) is disposed within the bore 638 of the coupling portion 604 to be arranged around the shaft 634. Specifically, the spring 654 includes a first end 658a and a second end 658b. The first end 658a of the spring 654 is configured to be received within a first recess 662 defined within an end surface 664 of the bore 638. The second end 658b of the spring 654 is configured to be received within a second recess (not shown) defined within the cap 626 of the lock 622. Also, the spring 654 is arranged within the bore 638 of the coupling portion 604 such that the second end 658b of the spring 654 extends beyond the locking projections 614a, 614b of the coupling portion 604 to help couple the quick-release lock 622 to the accessory 600.

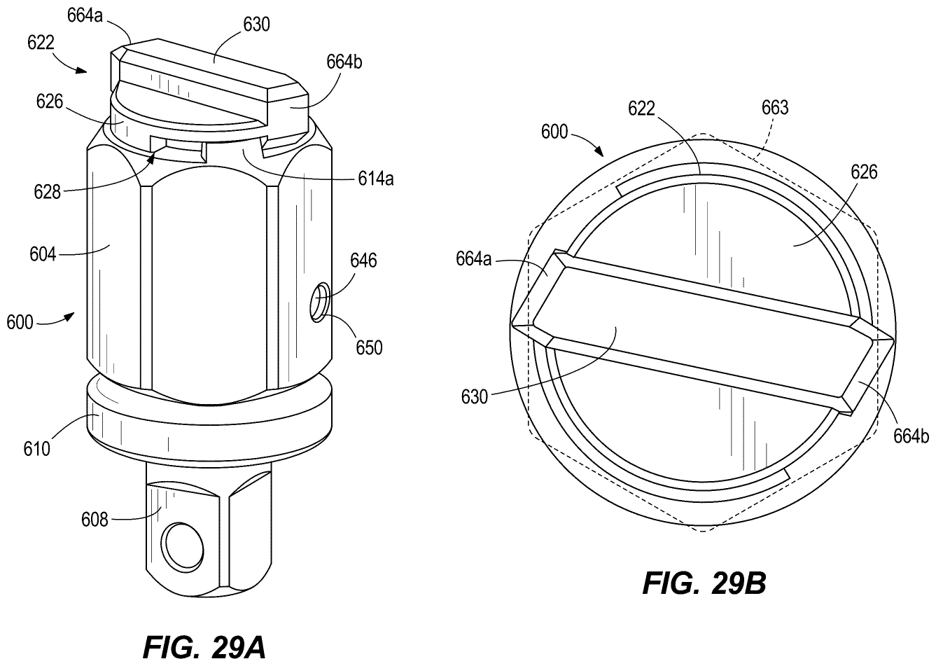

With reference to FIGS. 29A and 29B, the lock 622 is illustrated in a locked position when coupled to the accessory 600. A hexagonal outline 663, drawn with broken lines, is arranged along the accessory 600 to illustrate the profile of the drive bore 142 of the drive 126. End portions 664a, 664b of the gripping actuator 630 extend beyond the hexagonal outline 663 to indicate a locking position in which the end portions 664a, 664b are positioned to engage the flat top surface 202 of the drive 126 to lock the accessory 600 in place. As such, in the locked position, the quick-release lock 622 increases retention between the accessory 600 and the tool 10 to prevent the accessory 600 from being pulled through the tool 10.

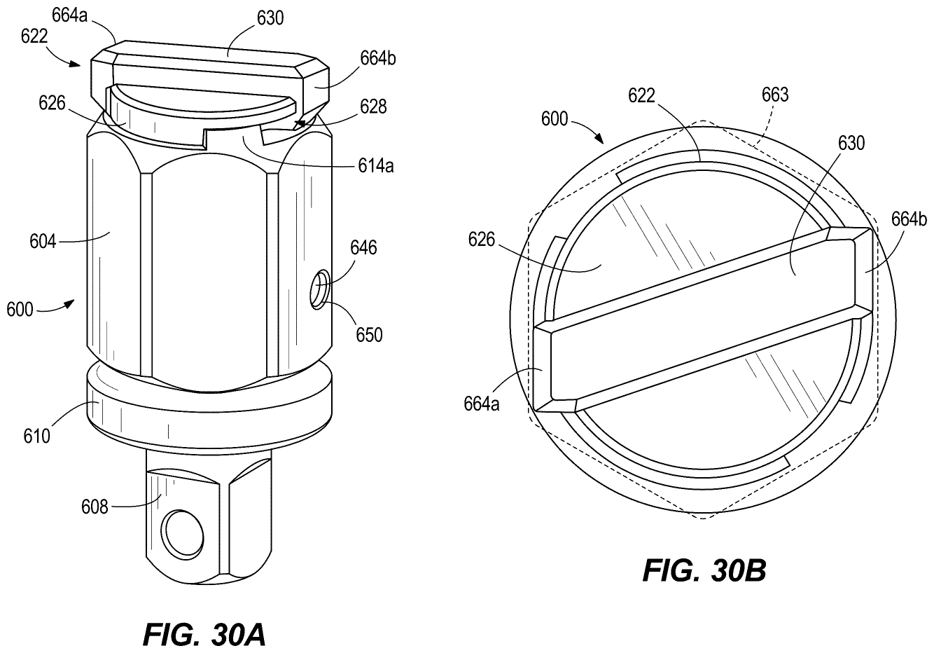

With reference to FIGS. 30A and 30B, the lock 622 is illustrated in an unlocked position when coupled to the accessory 600. A user may rotate the lock 622 in a counterclockwise or clockwise direction to move the lock 622 into the unlocked position. In some embodiments, the lock 622 may include indicia N printed, etched, engraved, etc. on the lock 622 to indicate the direction of rotation for moving the lock 622 toward the locked position and/or the unlocked position (FIG. 24B).

Returning to FIGS. 30A and 30B, the illustrated lock 622 is rotated about 30 degrees such that the end portions 664a, 664b of the gripping actuator 630 become parallel with the hexagonal outline 663. In other words, the end portions 664a, 664b of the gripping actuator 630 is parallel with the flat edges 214 of the drive bore 142 of the drive 126. As such, the accessory 600 is allowed to be removed from the tool 10. When rotating the quick-release lock 622 between the locked position and the unlocked position, each locking projection 614a, 614b of the coupling portion 604 moves within a respective recess 628 of the cap 626 to limit an amount at which the lock 622 rotates relative to the accessory 600.

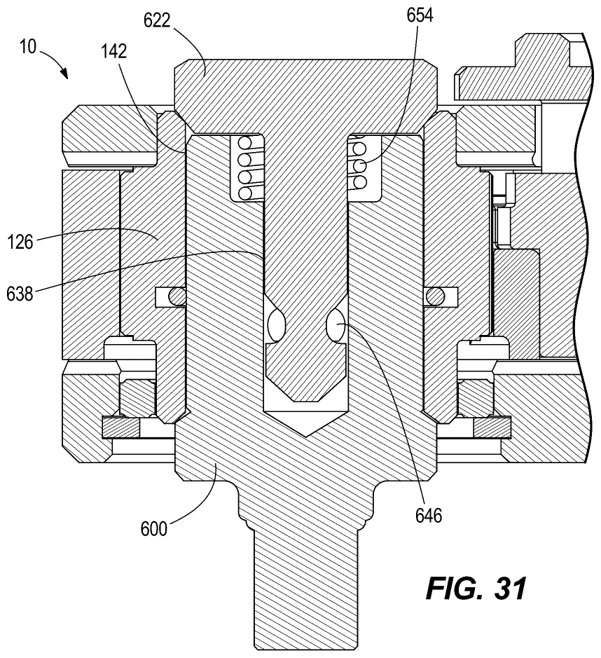

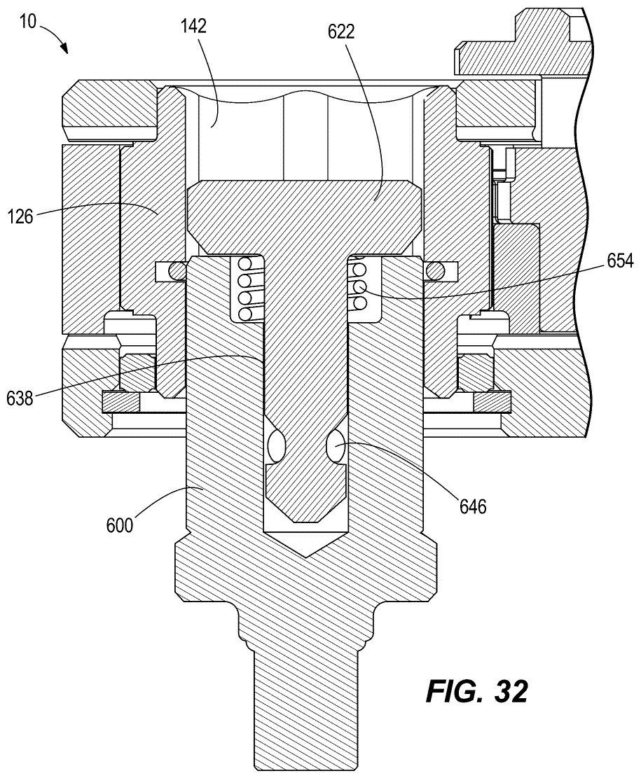

Also, when inserting the accessory 600 into the drive 126 of the tool 10, the quick-release lock 622 is rotated to the unlocked position. As such, the end portions 664a, 664b of the gripping actuator 630 are parallel with the flat edges 214 of the drive bore 142 to provide an easy coupling process between the tool 10 and the accessory 600. Once the accessory 600 is fully inserted into the drive 126, the lock 622 is then biased into the locked position by the spring 654. The accessory 600 and the lock 622 are respectively sized and shaped to match the angular configuration of the drive bore 142 (FIGS. 31 and 32). In addition, chamfers formed along the end portions 664a, 664b of the gripping actuator 630 permits depression of a C-ring provided along the drive 126 when inserting and removing the accessory 600 from the tool 10.

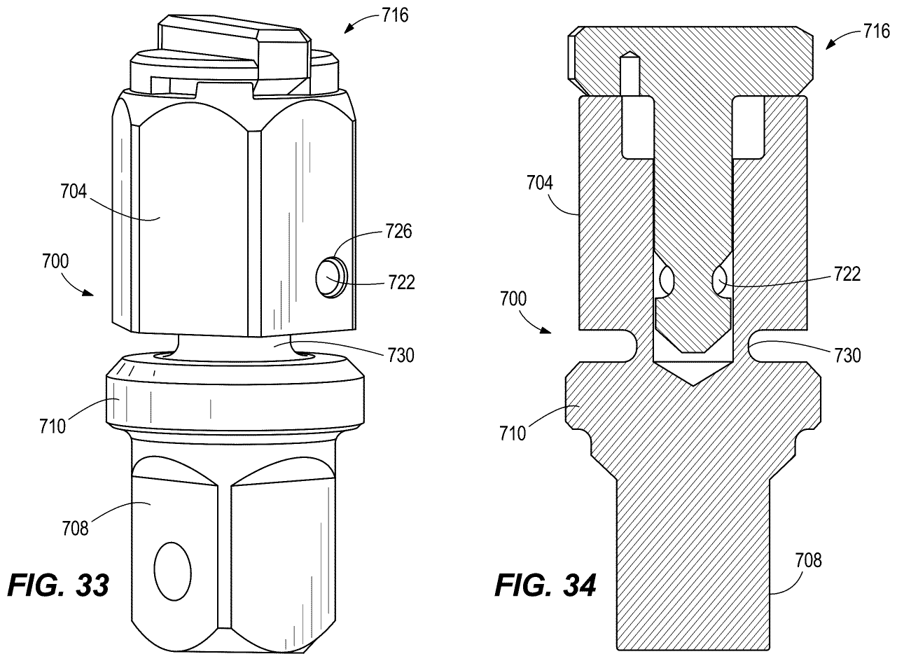

FIGS. 33 and 34 illustrate an accessory 700 according to another embodiment, which may be coupled to and used with the ratchet tool 10. The illustrated accessory 700 includes a coupling portion 704, an adapter portion 708, and a flange 710 formed along an end of the coupling portion 704 that is proximate the adapter portion 708. The coupling portion 704 of the accessory 700 has a hexagonal cross-sectional profile and is configured to be received within the drive bore 142 of the drive 126. The adapter portion 708 has a square cross-sectional profile and is configured to be coupled to a tool element (e.g., socket, tool bit, etc.) to perform work on a workpiece (e.g., fastener). The flange 710 functions as a stopping member configured to prevent the accessory 700 from falling through the drive 126. A quick-release lock 716 is coupled to the accessory 700 to help maintain the accessory 700 within the drive 126. The quick-release lock 716 is similar to the quick-release lock 622 of FIGS. 24-32. As such, a pin 722 is press-fitted into a hole 726 of the coupling portion 704 to engage the lock 716 and prevent removal of the lock 716 from the accessory 700.

The coupling portion 704 includes a necked (reduced diameter) region 730 proximate the flange 710. In the case that an excessive amount of torque is applied during manual operation of the tool 10, the necked region 730 can permit failure of the accessory 700, which is readily replaceable, before any other damage can be done to the tool 10 (e.g., to the gear assembly 70, the ratchet assembly 14, or the like). The necked region 730 may also indicate when failure may occur, and thereby result in an easier and faster repair process for a user.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. An accessory for a fastening tool having a pass-through drive including a bore bounded by a plurality of drive surfaces, the accessory comprising:
a coupling portion insertable into the bore from a first side of the bore in a first direction along an axis of the bore to couple the accessory for co-rotation with the pass-through drive about the axis;
an adapter portion extending from the coupling portion and configured to be coupled to a tool element to perform work on a workpiece; and
a lock rotatable relative to the coupling portion between a locked position, in which the lock engages a periphery of the bore, on a second of the bore opposite the first side, to prevent the accessory from being removed from the bore in a second direction opposite the first direction, and an unlocked position, in which the lock aligns with the plurality of drive surfaces to permit removal of the accessory from the bore in the second direction.

2. The accessory of claim 1, wherein the lock is biased toward the locked position.

3. The accessory of claim 1, wherein the lock is rotatable about the axis.

4. The accessory of claim 1, wherein the lock and the adapter portion are disposed on opposite sides of the coupling portion.

5. The accessory of claim 1, wherein the lock is rotatable between a plurality of locked positions and a plurality of unlocked positions.

6. The accessory of claim 5, further comprising a detent configured to retain the lock in a selected position of the plurality of locked positions and the plurality of unlocked positions.

7. The accessory of claim 1, wherein the coupling portion has a hexagonal profile, and wherein the adapter portion has a square profile.

8. The accessory of claim 1, further comprising a flange disposed between the adapter portion and the coupling portion, wherein the flange is engageable with a periphery of the bore on the first side of the bore to limit insertion of the accessory into the bore.

9. The accessory of claim 1, further comprising a detent ball supported by the adapter portion and configured to engage the tool element when the tool element is coupled to the adapter portion.

10. The accessory of claim 1, wherein the lock includes a body, a first projection extending from the body, and a second projection extending from the body, and wherein the first and second projections are configured to be misaligned with the plurality of drive surfaces when the coupling portion is inserted into the bore and the lock is in the locked position.

11. The accessory of claim 10, wherein the lock further includes a shaft extending from the body into a bore defined within the coupling portion, the shaft including a groove that receives a pin to retain the shaft within the coupling portion.

12. The accessory of claim 11, further comprising a torsion spring surrounding the shaft, the torsion spring biasing the lock toward the locked position.

13. The accessory of claim 1, further comprising indicia on the lock to indicate a direction of rotation of the lock from the locked position toward the unlocked position.

14. A kit comprising the accessory of claim 1, wherein the accessory is a first accessory, and wherein the kit further comprises a second accessory including a coupling portion and a lock identical to the coupling portion and the lock of the first accessory, and wherein the second accessory includes an adapter portion extending from the coupling portion and configured to be coupled to a tool element to perform work on a workpiece, the adapter portion of the second accessory being a different size than the adapter portion of the first accessory.

15. The kit of claim 14, further comprising a third accessory including a coupling portion and a lock identical to the coupling portion and the lock of the first accessory and the second accessory, and wherein the third accessory includes an adapter portion extending from the coupling portion and configured to be coupled to a tool element to perform work on a workpiece, the adapter portion of the third accessory being a different size than the adapter portions of the first and second accessories.

16. An accessory for a fastening tool having a pass-through drive including a bore bounded by a plurality of drive surfaces, the accessory comprising:
a coupling portion insertable into the bore in a first direction along an axis of the bore to couple the accessory for co-rotation with the pass-through drive about the axis;
an adapter portion extending from the coupling portion and configured to be coupled to a tool element to perform work on a workpiece; and
a lock assembly including an actuator, the actuator movable relative to the coupling portion along the axis between a locked position, in which the lock assembly prevents the accessory from being removed from the bore in a second direction opposite the first direction, and an unlocked position, in which the lock assembly permits removal of the accessory from the bore in the second direction.

17. The accessory of claim 16, wherein the lock assembly includes a wedge disposed within the coupling portion, the wedge being movable between an extended position, in which the wedge at least partially extends out of the coupling portion, and a retracted position, in which the wedge is disposed within the coupling portion.

18. The accessory of claim 17, wherein the wedge is movable from the extended position to the retracted position in response to movement of the actuator from the locked position to the unlocked position.

19. The accessory of claim 17, wherein the wedge is one of a plurality of wedges, each movable together between the extended position and the retracted position in response to movement of the actuator.

20. The accessory of claim 17, wherein the wedge is biased toward the extended position.

21. A fastening tool comprising:
a housing;
a motor supported within the housing;
a pass-through drive rotatable about an axis in response to operation of the motor, the pass-through drive including a bore bounded by a plurality of drive surfaces; and
an accessory including
a coupling portion insertable into the bore in a first direction along the axis to couple the accessory for co-rotation with the pass-through drive about the axis;
an adapter portion extending from the coupling portion and configured to be coupled to a tool element to perform work on a workpiece; and
a lock rotatable relative to the coupling portion between a locked position, in which the lock engages a periphery of the bore to prevent the accessory from being removed from the bore in a second direction opposite the first direction, and an unlocked position, in which the lock aligns with the plurality of drive surfaces to permit removal of the accessory from the bore in the second direction.
